(19) United States
(12) Patent Application Publication
(10) Pub. No.: US 2007/0084279 A1
(43) Pub. Date: Apr. 19, 2007

(54) APPARATUS AND METHOD FOR CONTROLLING MICRO-FLUID TEMPERATURE

(76) Inventors: Chien-Chih Huang, Taipei County (TW); Mei-Ya Wang, Tainan City (TW); Wen-Pin Liu, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,383

(22) Filed: Dec. 27, 2005

(30) Foreign Application Priority Data
Oct. 13, 2005 (TW) 94135663

(51) Int. Cl. G01F 1/68

(52) U.S. Cl. 73/204.26

(57) ABSTRACT

An apparatus for controlling micro-fluid temperature is provided. The apparatus includes a chip, a fixed stand, a heat-absorption block, and an actuator. The chip has a reaction chamber for disposing a micro-fluid, and the temperature of the micro-fluid rises by heating the chip to reach the required reaction temperature. In the cooling-down operation, the heat-absorption block can contact the chip when pushed by the actuator, so as to dissipate the heat from the chip by way of heat conduction. Moreover, in the heating operation, the heat-conductive block is out of contact with the chip such that the micro-fluid in the chip is quickly heated, so as to reach the required reaction temperature of the micro-fluid rapidly.

### CROSS-REFERENCE TO RELATED APPLICATION

This application claims the priority benefit of Taiwan application serial no. 94135663, filed on Oct. 13, 2005. All disclosure of the Taiwan application is incorporated herein by reference.

### BACKGROUND OF THE INVENTION

1. Field of Invention

The present invention relates to an apparatus for controlling temperature, and more particularly to an apparatus and method for controlling the micro-fluid temperature.

2. Description of Related Art

Polymerase Chain Reaction (PCR) is a process that a small amount of deoxyribonucleic acid (DNA) polymerase is used to conduct a specific chain reaction in a chip or within a test tube, where 10 billion to 100 billion copies of a single gene are generated so as to facilitate rapid detection of specific pathogenic nucleic acids or disease genes. DNA has a double-helix structure, and when DNA is replicated, the two complementary strands of the double helix bonded by hydrogen bonds have to be separated first into two single helixes to be replicated respectively. The simplest method for opening the DNA double helix is by heating. The double strands of DNA may be separated into single strands under high temperature, and the two complementary polymeric DNA strands can recover to double strands under a reduced temperature. As for the PCR, the DNA polymerase is put into a reaction chamber of a chip or into a heated test tube; and the temperature of the reaction chamber and the cycle of the reaction time are accurately controlled so as to replicate a specific gene fragment continuously and rapidly in this cycle.

Moreover, as for the traditional PCR chip, a little reagent is sealed in the reaction chamber; a heater and a temperature sensor are disposed adjacent to the reaction chamber to feedback control the temperature of the reaction chamber. Referring to FIG. 1, it is a schematic view of a conventional apparatus for controlling the micro-fluid temperature with a heat spreader for spreading the heat. In order to cool down the PCR chip 100 in a shorter period of time, the heat spreader 110 is arranged with heat sinks 112 in parallel, so as to dissipate the heat of the PCR chip 100 by way of heat conduction. In addition, a fan 120 can be further disposed on the heat sink 112, and the convection current generated by the fan 120 brings the heat away, thus cooling down the PCR chip 100 efficiently.

However, the heat spreader 110 with high heat capacity is fixed on the PCR chip 100, and when the temperature is raised, most heat generated by the heater is absorbed by the heat spreader 110, and accordingly the heat actually obtained by the PCR chip 100 reduces substantially. Since the heat spreader 110 is fixed on the PCR chip 100, the PCR chip 100 is heated up at a lower speed, and thus the time course of the whole temperature control is affected.

### SUMMARY OF THE INVENTION

An object of the present invention is to provide an apparatus for controlling micro-fluid temperature, capable of reducing the time course of whole temperature control through dynamic contact temperature control.

Another object of the present invention is to provide a method for controlling the micro-fluid temperature, capable of shortening the time course of the whole temperature control through dynamic contact temperature control.

The present invention provides an apparatus for micro-fluid temperature control, which comprises a chip, a fixed stand, a heat-absorption block, and an actuator. The chip has a reaction chamber for disposing a micro-fluid, and the fixed stand is used for holding the chip or the heat-absorption block. Additionally, with the heat-absorption block corresponding to the chip, the actuator can push the chip or the heat-absorption block to enable the chip and the heat-absorption block to move relative to each other. In the cooling-down operation, the actuator enables the heat-absorption block to be in contact with the chip, and in the heating operation, the actuator enables the heat-absorption block to be out of contact with the chip.

In an embodiment according to the present invention, the apparatus for controlling the micro-fluid temperature further comprises a switch. When the switch is ON, the actuator pushes the heat-absorption block to contact the chip, and when the switch is OFF, the actuator moves reversely to make the heat-absorption block out of contact with the chip, wherein the switch is, for example, a relay or a transistor switch.

In the preferred embodiment according to the present invention, the chip further includes a heater and/or a temperature sensor. The heater is, for example, a resistance wire heater used for heating up the micro-fluid, and the temperature sensor is, for example, a thermal resistance temperature sensor used for measuring the temperature change of the micro-fluid.

A method for controlling the micro-fluid temperature is further provided, which comprises the following steps: firstly, providing a chip having a reaction chamber, and injecting a micro-fluid into the reaction chamber; next, heating the chip to a reaction temperature, and bringing a heat-absorption block in contact with the chip in the cooling-down operation; then, bringing the heat-absorption block out of contact with the chip in the heating operation.

In the preferred embodiment according to the present invention, in the cooling-down operation, the heat-absorption block contacts the chip when pushed by the actuator, for example, and then in the heating operation, the heat-absorption block is moved away from the chip by the actuator.

The apparatus for controlling the micro-fluid temperature of the present invention employs the heat-absorption block to contact the chip for the cooling-down operation, thus the temperature of the micro-fluid lower drops to a predetermined level in a very short time. However, in the heating operation, the heat-absorption block is out of contact with the chip, such that the micro-fluid in the chip can be rapidly heated up, and the time course of the whole temperature control is accelerated.

In order to the make the aforementioned and other objects, features and advantages of the present invention more comprehensible, preferred embodiments accompanied with appended drawings are described in detail below.

### BRIEF DESCRIPTION OF THE DRAWINGS

FIG. 1 is a schematic view of a conventional apparatus for controlling the micro-fluid temperature with a heat spreader for spreading the heat.

FIG. 2 is a schematic view of an apparatus for controlling the micro-fluid temperature according to a preferred embodiment of the present invention.

FIG. 3 is a schematic view of the position of the heat-absorption block of the apparatus for controlling the micro-fluid temperature in a heating operation according to the present invention.

FIG. 4 is a schematic view of the action of the heat-absorption block of FIG. 3 in the cooling-down operation.

FIG. 5 is a temperature control curve for the PCR performed by the apparatus for controlling the micro-fluid temperature according to the present invention.

FIG. 6 is a conventional temperature control curve, with a heat spreader for spreading the heat and with a fan for generating heat convection currents.

### DESCRIPTION OF EMBODIMENTS

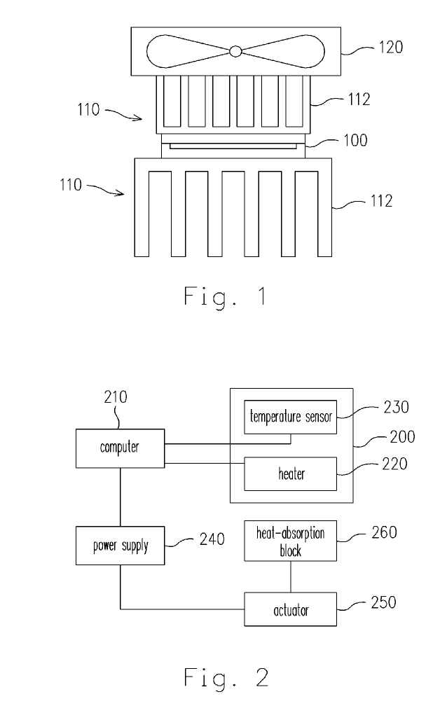

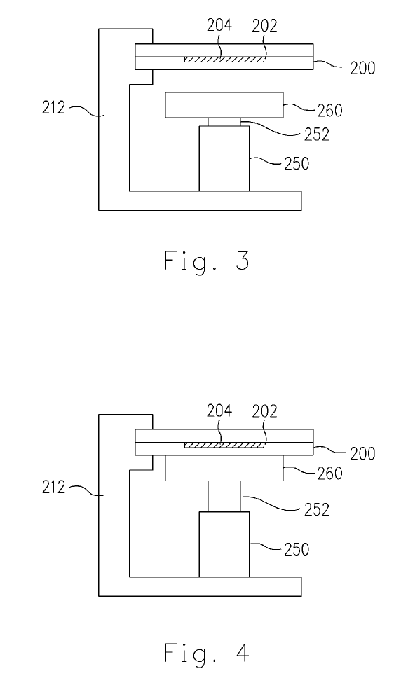

FIG. 2 is a simple schematic view of an apparatus for controlling the micro-fluid temperature according to a preferred embodiment of the present invention. Referring to FIG. 2, a set of automatic temperature control systems can be configured by a chip 200 of the apparatus for controlling the micro-fluid temperature incorporated with the automatic control of a computer 210. The computer 210 has a hardware or software for automatic program control, to turn on or turn off the heater 220 according to the predetermined temperature conditions, so as to heat the micro-fluid in the chip 200 to a predetermined temperature. Since there is only tens of micro liters of micro-fluid, it is very easy to heat up the micro-fluid. Moreover, the computer 210 can also receive the signal output from the temperature sensor 230 to feedback control the temperature of the chip 200. Additionally, the chip 200 of the apparatus for controlling the micro-fluid temperature can further be incorporated with the voltage modulation signal provided by a power supply 240 to drive the actuator 250 back and forth, so as to make the heat-absorption block 260 and chip 200 move relative to each other. In the heating operation, the actuator 250 can move the heat-absorption block 260 or the chip 200 to bring the heat-absorption block 260 out of contact with the chip 200, as shown in FIG. 3. In the cooling-down operation, the actuator 250 can push the heat-absorption block 260 or the chip 200 to bring the heat-absorption block 260 and the chip 200 in contact, as shown in FIG. 4.

Referring to FIG. 3, it is a schematic view of the position of the heat-absorption block of the apparatus for controlling the micro-fluid temperature in a heating operation according to the present invention. The heat-absorption block 260 is made of, for example, a metal with high thermal conductivity coefficient, such as copper and aluminum. In the heating operation, the heat-absorption block 260 is out of contact with the chip 200, thus the micro-fluid 204 sealed within a reaction chamber 202 of the chip 200 can be heated to the reaction temperature rapidly. In the embodiment, a resistance wire heater or other heater (not shown) can be disposed on the chip 200, to enable the micro-fluid 204 in the reaction chamber 202 to be heated to the reaction temperature evenly. The chip 200 is, for example, clamped by a fixed stand 212, and the heat-absorption block 260 is, for example, fixed on a push rod 252 of the actuator 250 and is separated from the chip 200 by a distance. Of course, the way of fixing the chip 200, the shape of the fixed stand 212, the way of driving the actuator 250, and the material and size of the heat-absorption block 260 are not limited in the present invention. In another embodiment, the heat-absorption block 260 is clamped on the fixed stand 212, and the chip 200 is fixed on the actuator 250.

Referring to FIG. 4, a schematic view of the action of the heat-absorption block of FIG. 3 in the cooling-down operation is shown. Since the heat capacity of the chip 200 is lower than that of the metal heat-absorption block 260, when heat-absorption block 260 contacts the chip 200 when pushed by the actuator 250, the heat-absorption block 260 will absorb most of the heat to cool down the chip 200 rapidly by way of heat conduction. Compared with the conventional technology where the heat spreader is fixed on the chip which may affect the heating speed of the chip, the present invention has better cooling-down, heating control by contacting the chip 200 dynamically. In the heating operation, since only the chip 200 needs to be heated (the chip 200 is separated from the heat-absorption block 260), the chip 200 is heated more rapidly. In the cooling-down operation, since the chip 200 contacts the heat-absorption block 260, the chip 200 is cooled down more rapidly as well. As the heating/cooling-down speed is the main factor that affects the time course of temperature control, the time course of the whole temperature control will be substantially shortened in the cycle of the repeated operations, thus the efficiency of the biochemical reaction will be improved.

The application of a bio-chip for accurately controlling the micro-fluid temperature, so as to rapidly detect the PCR of specific pathogenic nucleic acids or disease genes, or to break cells in the micro-fluid under high temperature to detect the substances in the cells such as protein or DNA, etc., or the endurance tests in other fields requiring rapid temperature increase and decrease, etc., can all be implemented by the above apparatus for dynamic contact temperature control. In the apparatus, the actuator 250 can drive the chip 200 or the heat-absorption block 260 back and forth by using an electromagnetic actuator or a shape memory alloy actuator to enable the chip 200 and the heat-absorption block 260 to move relative to each other. Moreover, the actuator 250 can also control the heat-absorption block 260 to move forwards or backwards by hydraulic drive, pneumatic drive, ultrasonic drive, or other actuator (not shown) operations. For example, the actuator 250 can activate the signals to move forwards and backwards by a switch (not shown). When the switch is ON, the actuator 250 pushes the heat-absorption block 260 to be in contact with the chip 200; and when the switch is OFF, the actuator 250 reacts reversely to bring the heat-absorption block 260 out of contact with the chip 200. The type of the switch includes a relay, a transistor, or switches in other forms.

Referring to FIG. 5, it is a temperature control curve for a PCR performed by an apparatus for controlling the micro-fluid temperature according to the present invention. X axis is set as the reaction time and Y axis is set as the temperature of the micro-fluid. Wherein the solid line indicates the temperature of PCR reaction in one cycle and the corresponding set values of the time; and the dotted line indicates the temperature of the reaction chamber of the chip measured by a thermocouple temperature sensor or other sensors. It should be noted that during the heating operation (interval A-B), the temperature of the reaction chamber in the chip rapidly is raised from 59° C. to about 90° C. by a heater; when decreasing the temperature (interval B-C), the temperature of the reaction chamber rapidly is cooled down from 90° C. to about 54° C. by contacting the chip with the heat-absorption block, with a decrease rate of about 19° C. per second. Therefore, by repeating the PCR reaction for 30 cycles in a manner of dynamic contact temperature control described above, the time required for rapidly replicating a specific gene fragment to a detection quantity can be shortened to about 25 minutes, thus greatly shortening the time for the whole biochemical reaction.

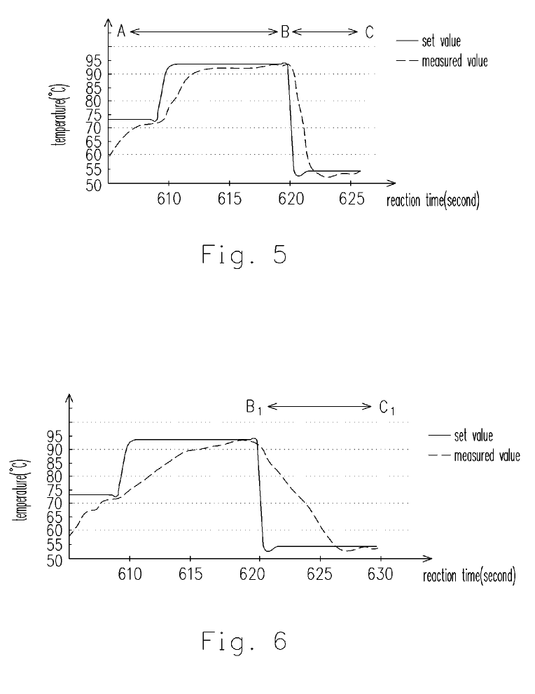

Please refer to FIG. 5 together with FIG. 6. FIG. 6 is a conventional temperature control curve, with a heat spreader for conducting the heat and with a fan for generating heat convection currents. As shown by the dotted line, the temperature of heating chip is raised slowly, and in the cooling-down operation (interval B1-C1), the temperature of the reaction chamber of the chip measured by the temperature sensor drops from 94° C. to about 54° C., that is, with a decrease rate of about 3.25° C. per second, and the cooling-down speed is obviously lower than that of the present invention.

To sum up, the apparatus for controlling the micro-fluid temperature of the present invention uses the heat-absorption block to contact the chip for a cooling-down operation, thus enabling the temperature of the micro-fluid to drop to a predetermined level in a very short time. In the heating operation, the heat-absorption block is out of contact with the chip, such that the micro-fluid in the chip can be rapidly heated up, thus the time course of the whole temperature control is accelerated. Therefore, the efficiency of the whole biochemical reaction is obviously improved.

Although the present invention is disclosed as above by preferred embodiments, they are not intended to limit the present invention. Various variations and modifications can be made by those skilled in the art without departing from the spirit and scope of the present invention, and the scope of the present invention shall be defined by the appended claims.

What is claimed is:

1. An apparatus for controlling the micro-fluid temperature, comprising:
a chip, having a reaction chamber for disposing a micro-fluid;
a heat-absorption block, corresponding to the chip;
a fixed stand, for holding the chip or the heat-absorption block; and
an actuator, pushing the chip or the heat-absorption block to make the chip and the heat-absorption block move relative to each other, wherein the actuator is suitable for bringing the heat-absorption block in contact with the chip in a cooling-down operation and bringing the heat-absorption block out of contact with the chip in a heating operation.

2. The apparatus for controlling the micro-fluid temperature as claimed in claim 1, further comprising a switch, wherein when the switch is ON, the actuator pushes the heat-absorption block to contact the chip, and when the switch is OFF, the actuator enables the heat-absorption block to be out of contact with the chip.

3. The apparatus for controlling the micro-fluid temperature as claimed in claim 2, wherein the switch is a relay or a transistor switch.

4. The apparatus for controlling the micro-fluid temperature as claimed in claim 1, wherein the actuator further comprises a push rod for connecting the heat-absorption block.

5. The apparatus for controlling the micro-fluid temperature as claimed in claim 1, wherein the actuator is an electromagnetic actuator, or a shape memory alloy actuator.

6. The apparatus for controlling the micro-fluid temperature as claimed in claim 1, wherein the actuator is a hydraulic actuator, a pneumatic actuator, or an ultrasonic actuator.

7. The apparatus for controlling the micro-fluid temperature as claimed in claim 1, wherein the material of the heat-absorption block comprises copper or aluminum.

8. The apparatus for controlling the micro-fluid temperature as claimed in claim 1, wherein the chip further comprises a heater disposed adjacent to the reaction chamber.

9. The apparatus for controlling the micro-fluid temperature as claimed in claim 7, wherein the heater comprises a resistance wire heater.

10. The apparatus for controlling the micro-fluid temperature as claimed in claim 1, wherein the chip further comprises a temperature sensor disposed adjacent to the reaction chamber.

11. The apparatus for controlling the micro-fluid temperature as claimed in claim 9, wherein the temperature sensor comprises a thermal resistance temperature sensor.

12. A method for controlling the micro-fluid temperature, comprising:
providing a chip with a reaction chamber;
injecting a micro-fluid into the reaction chamber;
heating the chip to a reaction temperature;
bringing a heat-absorption block in contact with the chip in a cooling-down operation; and
bringing the heat-absorption block out of contact with the chip in a heating operation.

13. The method for controlling the micro-fluid temperature as claimed in claim 12, wherein the method of bringing the heat-absorption block in contact with the chip comprises pushing the heat-absorption block or the chip by an actuator to make the heat-absorption block and the chip in contact.

14. The method for controlling the micro-fluid temperature as claimed in claim 12, wherein the method of bringing the heat-absorption block out of contact with the chip comprises moving the heat-absorption block or the chip by an actuator to enable the heat-absorption block to be out of contact with the chip.
